(19) United States
(12) Patent Application Publication
(10) Pub. No.: US 2015/0284080 A1
(43) Pub. Date: Oct. 8, 2015

(54) SPECIAL FORCES REPLENISHMENT VEHICLE

(71) Applicant: Raytheon Company, Waltham, MA (US)

(72) Inventors: Andrew B. Facciano, Tucson, AZ (US); Cody D. Tretschok, Tucson, AZ (US); Rodney H. Krebs, Oro Valley, AZ (US); Patrick D. Kranking, Marana, AZ (US)

(21) Appl. No.: 14/471,129

(22) Filed: Aug. 28, 2014

Related U.S. Application Data
(60) Provisional application No. 61/871,008, filed on Aug. 28, 2013.

(51) Int. Cl. B64D 1/12; B64C 9/32

(52) U.S. Cl. CPC B64D 1/12; B64C 9/32

(57) ABSTRACT

A replenishment vehicle, such as a special forces replenishment vehicle is configured for being carried by and released from an aircraft. The replenishment vehicle, also referred to as a payload container, includes a storage cavity for storing a payload for being delivered to a target area. The payload may include any suitable provisions, and preferably provisions that are non-explosive during landing of the payload container, such as supplies for troops/operatives in the field, self-deploying radar or other detection devices, etc. The payload container is lobbed from the aircraft, such that the payload container is released while the aircraft is proceeding at an upwards trajectory. The payload container may be guided towards the target area by a guide portion such as a fin, wing, sail, chute, etc. The payload container is configured to enable the payload to survive release of the payload container from the aircraft and a subsequent landing.

### RELATED APPLICATIONS

This application claims the benefit of U.S. Provisional Application No. 61/871,008, filed Aug. 28, 2013, which is hereby incorporated herein by reference.

### FIELD OF THE INVENTION

The invention relates generally to deployment container and more particularly to a guidable deployment vehicle for providing a payload to a designated area.

### DESCRIPTION OF THE RELATED ART

Containers for storing and deploying payloads are used to drop supplies or other equipment to target areas, such as to troops in the field. The containers are often dropped from low-altitude flying vehicles, such as cargo planes, bombers, helicopters, etc. The low-altitude flying vehicles and containers themselves are often easily detectable both by radar and by sight from ground-based locations.

### SUMMARY OF THE INVENTION

The present disclosure provides a payload container and method of deploying a payload container for supplying supplies and/or any other suitable payload to a target area with the payload surviving the landing. The payload container may be carried and released in a manner to avoid detection, and/or the payload container itself may be constructed to avoid detection. The payload container is carried by an aircraft, such as a high-altitude aircraft, and preferably a high-altitude fighter aircraft. The payload container is released from the aircraft, preferably with a non-propelled separation, and preferably during an upwards ascent of the aircraft, such as to lob the payload container from the aircraft. The payload container may include a guiding portion for adjusting a trajectory of the payload container to guide it towards a target area, with the payload within the payload container surviving a subsequent landing.

According to an aspect, there is a method of deploying a payload container containing a payload from an aircraft. The method includes lobbing the payload container from the aircraft, guiding the payload container towards a target area by adjusting a guide portion of the payload container, and following the guiding, landing the payload container with the payload surviving the landing.

Adjusting the guide portion may include deploying a sail, deploying a chute, and/or adjusting an angle of an airfoil.

Landing the payload container with the payload surviving the landing may include crushing a crushable portion of the payload container having lesser impact strength than adjacent portions, the crushable portion being deformable upon impact.

Landing the payload container with the payload surviving the landing may include deploying a chute.

Lobbing the payload container may include lobbing the payload container from a fighter aircraft or releasing the payload container from the aircraft while at an altitude of at least 8 km.

According to another aspect, there is a method of providing a non-explosive payload to a target area. The method includes storing the payload in a cavity of a payload container, loading the payload container onto an aircraft, flying the aircraft at an upwards trajectory, releasing the payload container from the aircraft while at the upwards trajectory, guiding the payload container towards the target area after releasing the payload container, survivably landing the payload container, and separating the payload from the payload container.

Survivably landing the payload container may include crushing a crushable portion of the payload container having lesser impact strength than adjacent portions, the crushable portion being deformable upon impact.

Survivably landing the payload container may include deploying a chute.

Guiding the payload container may include adjusting a guide portion of the payload container to adjust the trajectory of the payload container.

Releasing the payload container may include releasing at an altitude of at least 8 km or releasing from a fighter aircraft.

According to yet another aspect, there is a payload container for lobbing from an aircraft. The payload container includes an outer body defining an interior cavity for storing a payload, an attachment interface attachable to the aircraft, and a guide portion activatable upon detachment of the payload container from the aircraft to guide the payload container towards a target area. The outer body extends along a longitudinal axis between a lead end and a tail end, with at least one of the lead or tail ends having an ogive-shaped axial end, and the outer body being streamlined between the lead and tail ends.

The guide portion may be a chute, a sail and/or an airfoil.

The outer body may include at least one crushable portion having lesser impact strength than adjacent portions, the crushable portion being deformable upon impact.

The payload container may be combined with a fighter aircraft having an aircraft attachment interface for receiving the payload container attachment interface.

The guide portion may extend from an external surface of the outer body.

To the accomplishment of the foregoing and related ends, the invention comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF DRAWINGS

The annexed drawings, which are not necessarily to scale, show various aspects of the disclosure.

FIG. 1 is a bottom view of an aircraft carrying a container according to an embodiment of the disclosure.

FIG. 2 is a close-up view of the aircraft of FIG. 1 showing the container attached to the aircraft.

FIG. 3A is a side view of another container according to an embodiment of the disclosure.

FIG. 3B is a side view of yet another container according to an embodiment of the disclosure.

FIG. 3C is a side view of still another container according to an embodiment of the disclosure.

FIG. 3D is a side view of another container according to an embodiment of the disclosure.

FIG. 4A is a cross-sectional view of the container of FIG. 3A.

FIG. 4B is another cross-sectional view of another container according to FIG. 3A.

FIG. 5A is an elevational view of a container according to FIG. 3A.

FIG. 5B is another elevational view of a container according to FIG. 3A.

FIG. 6 is schematic showing the deployment of the container of FIG. 3A.

### DETAILED DESCRIPTION

A replenishment vehicle, such as a special forces replenishment vehicle is configured for being carried by and released from an aircraft. The replenishment vehicle, herein also referred to as a payload container, includes a storage cavity for storing a payload for being delivered to a target area. The payload may include any suitable provisions, and preferably provisions that are non-explosive during landing of the payload container. The provisions may include supplies for troops/operatives in the field, self-deploying radar or other detection devices, etc. The payload container may be lobbed from the aircraft, such as without a propelled separation from the aircraft. The payload container is configured to enable the payload to survive release of the payload container from the aircraft and a subsequent landing.

While the description detailed herein is described in conjunction with deployment of provisions into the field for militaristic or special forces purposes, the description is also applicable to other suitable uses. For example, the payload container may be utilized for delivery of food, medicine, and/or other suitable supplies to any suitable persons or locations, such as in the case of delivery to third-world countries or delivery to expeditions. It will also be appreciated that the payload container may be applicable to any other suitable delivery of domestic provisions.

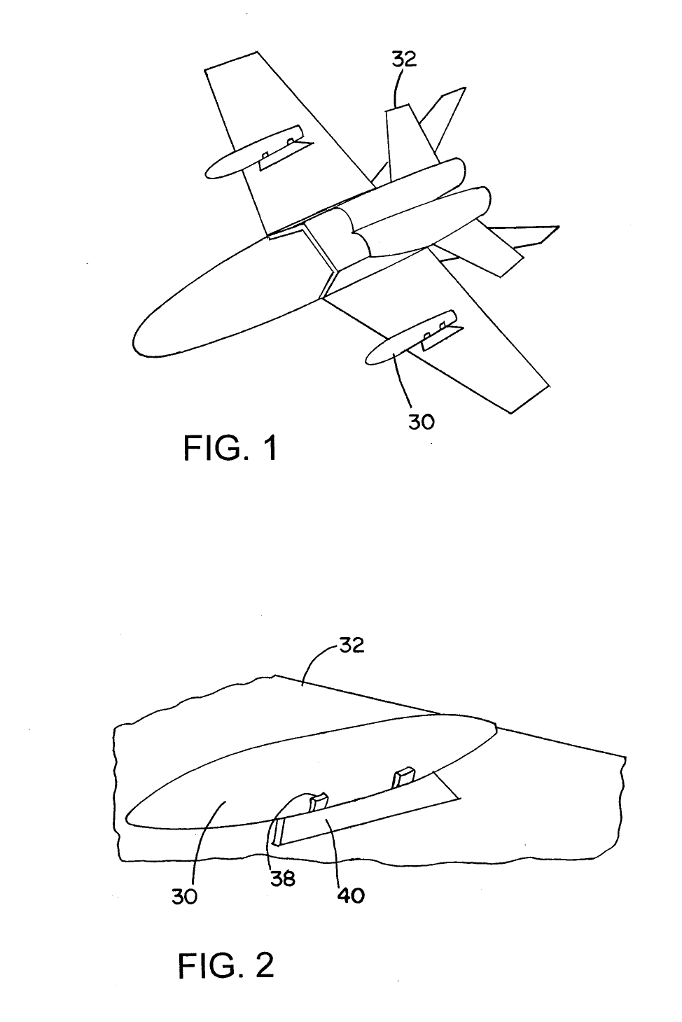

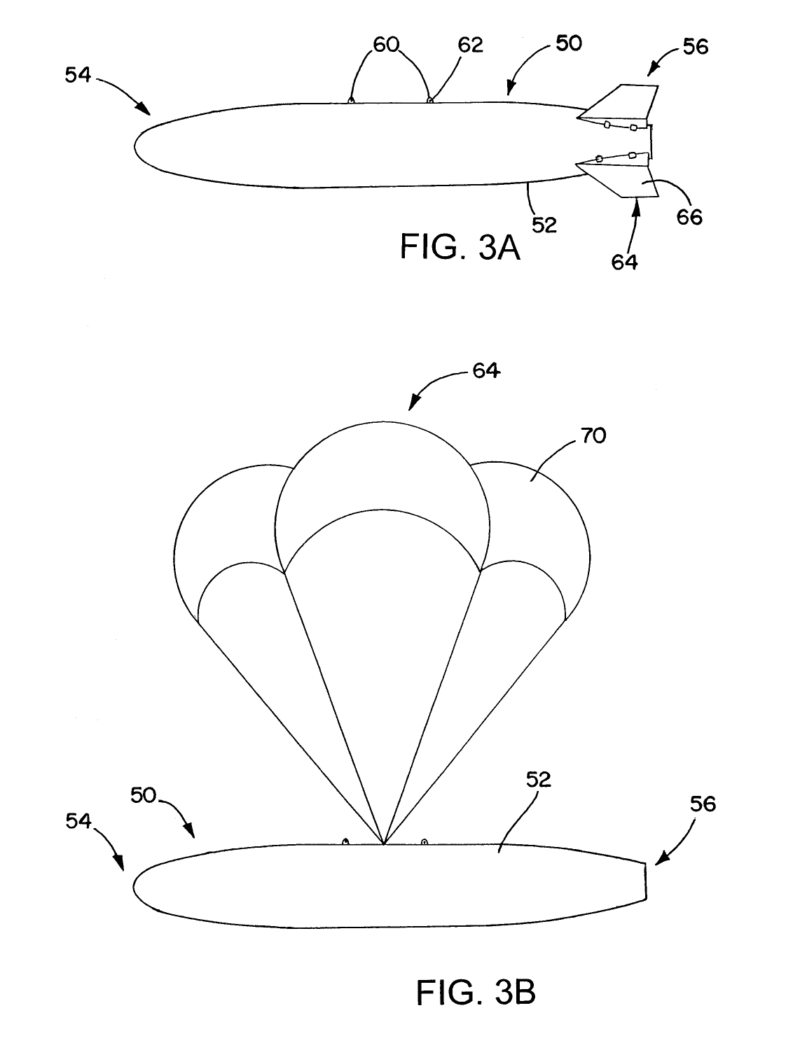

Accordingly, in one example, a payload container 30 for being deployed to a target area by an aircraft 32 is shown in FIGS. 1 and 2. The payload container 30 is configured for being carried by the aircraft 32. The aircraft 32 is shown as a high-altitude aircraft, and preferably as a high-altitude fighter aircraft. In other embodiments, the aircraft may be any other suitable high-altitude aircraft such as a high-altitude bomber, drone, etc. In still other embodiments, an aircraft for carrying the payload container 30 may be a suitable low-altitude aircraft such as a low-altitude bomber, cargo plane, helicopter, drone, etc.

Use of a high-altitude aircraft for deploying the payload container 30 provides the advantage of high-altitude release of the payload container 30 from the aircraft 32, allowing a greater distance between a point of release and a target area as compared to low-altitude release. In this way, the payload container 30 may be released far from a target area to avoid both detection of the aircraft 32 and to provide the illusion that the aircraft 32 and/or the payload container 30 do not have a planned destination of the target area.

As depicted in FIG. 1, the payload container 30 may be carried on a wing of the aircraft 32, preferably in the place of a fuel tank of the aircraft 32. As shown in FIG. 2, the payload container may include a suitable container attachment interface 38, such as a rack linkage, for attachment to a suitable aircraft attachment interface 40, such as a fuel tank rack or a bomb rack. In other embodiments, the payload container 30 may be carried on an aircraft fuselage, in an openable storage bay, or in/on any other suitable aircraft location.

In some embodiments the release of the payload container 30 from the aircraft 32 may include a non-propelled separation, such as without fluid (gas, liquid, or combination thereof) propulsion, pyrotechnics, or other explosives or mechanisms which may create detectable contrails, exhaust trails, and/or heat signatures. Thus, the container attachment interface 38 may include lugs which may simply be released from the corresponding aircraft attachment interface 40 such as to drop or lob the payload container 30 from the aircraft 32. In this manner the payload container 30 will continue along a trajectory away from the aircraft 32 at the point of release using maintained kinetic energy of the payload container 30.

In the case of the payload container 30 being carried in the place of a fuel tank of the aircraft 32, such as on the aircraft wing or fuselage, the payload container 30 may be configured, such as shaped, to generally resemble a fuel tank. In this way, the payload container 30 may be loaded onto the aircraft 32 in the open, and observers will substantially be unable to discern between a fuel tank and the payload container 30.

In one embodiment, the payload container 30 may be formed from a fuel tank and preferably from a decommissioned fuel tank. An outer shell of the fuel tank may be the outer shell of the payload container, and an inner volume defined by the outer shell may be configured to define one or more storage cavities for containing payloads. One or more guide portions may be added to the fuel tank, such as an airfoil extending from an external surface of the fuel tank. In some embodiments addition of external features to the fuel tank is minimized to reduce recognition of the payload container as a payload container and to promote mistaken recognition of the payload container as merely a fuel tank.

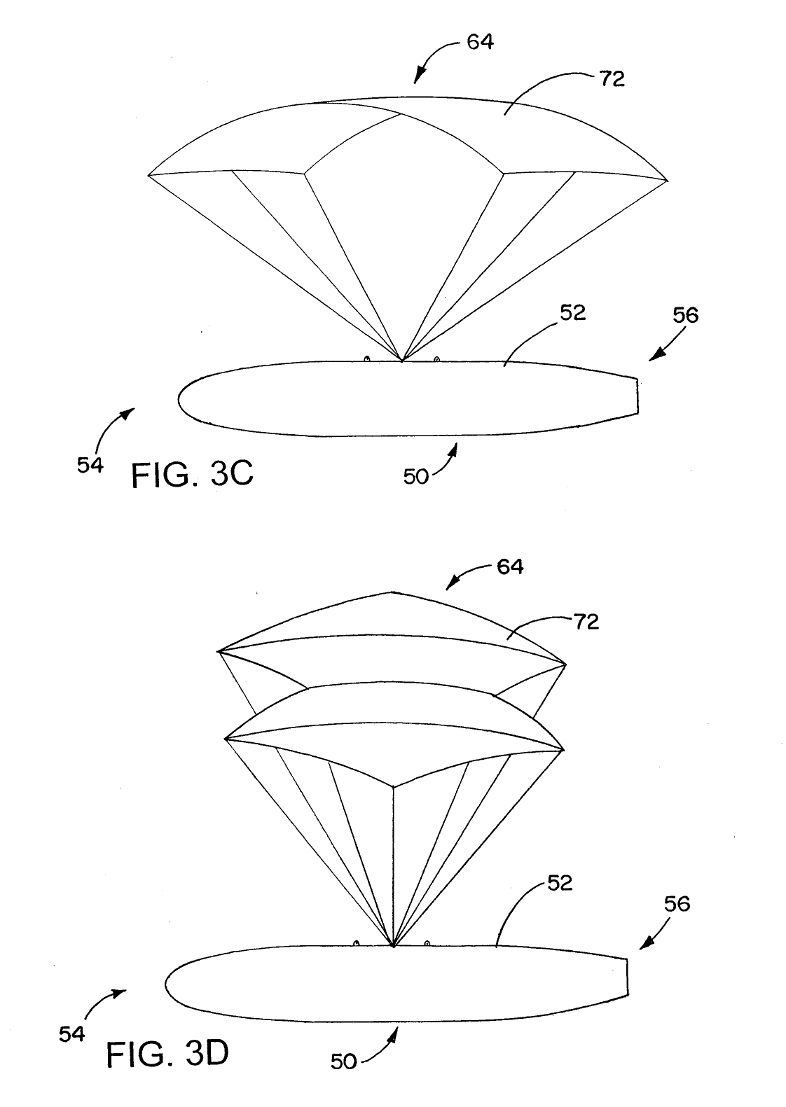

Turning now to FIGS. 3A-3D, 4A and 4B, and 5A and 5B, another payload container is shown at 50. Any of the embodiments of the payload container 50 shown in FIGS. 3A-3D, 4A, 4B, 5A and 5B may be utilized with the aircraft 32 of FIGS. 1 and 2. Features of the payload container 30 may be included in the payload container 50 and vice versa.

The illustrated payload container 50 is shaped and/or sized to generally avoid detection after release from an aircraft. Thus the container 50 may have a narrow profile along at least one axis of the container 50. Additionally or alternatively, the container 50 may include an external shell composed of a material capable of deflecting detection signals, such as radar pings. In one embodiment the container 50 may include an external shell composed of a material for reducing an external temperature of the container 50 to reduce the container's heat signature and/or to reduce production of contrails.

The illustrated payload container 50 includes an outer body 52 that extends along a central longitudinal axis between a lead axial end 54 and a tail axial end 56. As shown, the outer body 52 is streamlined between the lead axial end 54 and the tail axial end 56. The lead end 54 is shown as ogive-shaped, although the lead end 54 may be of any other suitable shape for deployment from an aircraft. Further the tail axial end 56 may also be of any suitable shape for deployment from an aircraft. The depicted outer body 52 also includes an attachment interface 60, shown as attachment lugs 62, for enabling attachment to and release from an aircraft, such as from an aircraft attachment interface.

Guide portions 64 are included in or on the payload container 50 for guiding the payload container 50 towards a target area after release from an aircraft. For example a guide portion 64 may extend outwardly from an external surface of the payload container 50. The guide portions 64 may be adjustable to adjust a trajectory of the payload container 50 during its descent to landing. The guide portions 64 may provide for guiding including creating thrust, or preferably may provide for producing guiding of the payload container 50 towards a target area without production of detectable thrust.

To enable the payload container 50 to be generally undetectable such as to radar or visual detection, the guiding may be free of detectable-thrust-producing guide portions 64 such as rockets, jets, liquid or gas jets, etc. These detectable-thrust-producing guide portions may produce and release gases, such as hot gases, and/or create contrails, exhaust trails and/or heat signatures making the payload container 50 easy to detect. Though these detectable-thrust-producing guide portions may be included in other payload container embodiments having detectable-thrust-producing guidance.

Non-detectable-thrust-producing guide portions 64 may include powered components, such as motors, servos, solenoids, etc. for adjusting one or more of the guide portions 64, such as to alter the trajectory of the payload container 50. The adjusting may include adjusting an angle, rotating, pivoting and/or translating one or more guide portions 64.

For example, as shown in FIG. 3A, the guide portions 64 are airfoils 66, and one or more of the airfoils 66 may be pivotable along an axis orthogonal to the central longitudinal axis of the payload container 50 to change direction of the payload container 50 during descent, such as in an atmosphere. A suitable airfoil 66 may include a wing, fin, flipper, aileron, stabilizer, etc.

The airfoils 66 of FIG. 3A are circumferentially spaced about the tail axial end 56 and extend radially outwardly from the tail axial end 56. Shape and size of the airfoils 66 may be reserved or minimized in the case that the payload container 50 is constructed to be generally observed as a fuel tank. One or more airfoils 66 may be included, and the payload container 50 may be configured to deploy the airfoils 66, such as via springs.

Other embodiments of the payload container 50 may include additional or alternative guide portions 64, as shown in FIGS. 3B-3D, each which show non-detectable-thrust-producing guide portions. For example, the payload container 50 may include a chute 70 (FIG. 3B), a sail 72 such as a parasail (FIG. 3C) and/or a wing sail (FIG. 3D). Other guide portions 64 may include a propeller, other stabilizers and/or anti-tumbling projections.

Any of the described guide portions 64 may be stored internally in an internal volume of the payload container 50 for deployment close to the time of release from the aircraft, such as prior to, during, or after release from the aircraft. For example, one or more guide portions 64 may be activatable upon detachment of the payload container 50 from the respective aircraft, and more preferably after an additional time period after separation from the aircraft, thus providing for additional distance between the payload container 50 and the aircraft so as to minimize effect of aircraft draft on the one or more guide portions 64.

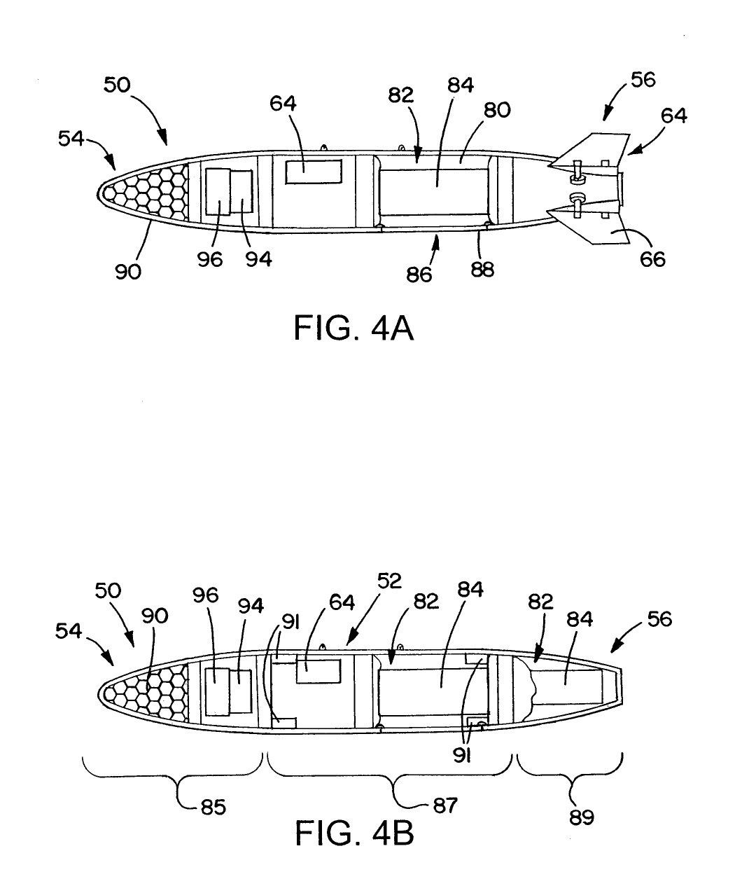

Referring now specifically to FIG. 4A, the payload container 50 is shown in cross-section. The outer body 52 defines an internal volume 80 that includes one or more storage cavities 82 for storing a payload 84. As shown in FIG. 4A, the payload 84 may be loaded into and removed from a storage cavity 82 via an opening 86 that is closed by a closing member, such as an access panel 88. The access panel 88 may be attached to the outer body 52 by any suitable method such as by screws, bolts, welding, adhesives, hinges, etc.

In another embodiment of the payload container 50 shown in FIG. 4B, the outer body 52 may define a nose section 85, intermediate section 87, and tail section 89. The intermediate section may define one or more storage cavities 82 for storing a payload 84. The nose section 85 and/or tail section 89 may be separable from the intermediate section 87 for loading the payload 84 into and removing the payload 84 from the storage cavity 82. The nose, intermediate and tail sections 85, 87 and 89 may be selectively and separably connected to one another via any suitable method, such as by screws, bolts, welding, adhesives, hinges, etc.

In either of the embodiments of FIG. 4A or 4B the payload container 50 may include a separation mechanism for causing separation of the access panel 88 from the payload container or the nose or tail sections 85 and 89 from the payload container, respectively. The separation mechanism may include pyrotechnics, electrically, mechanically, or chemically actuated actuators, etc. As shown in FIG. 4B one exemplary separation mechanism may be a linear actuator 91. Additionally or alternatively the access panel 88 and/or nose/tail sections 85/89 may be connected to the remainder of the payload container 50 via hinges and/or a frangible connection.

The payload 84 stored in the one or more storage cavities 82 of the payload container 50 may be provisions, and preferably non-explosive provisions that are non-explosive during landing of the payload container 50. Thus the non-explosive provisions are stored in the one or more storage cavities 82 of the payload container 50 such as to survive impact and/or landing of the payload container 50, unlike in the case of a warhead carried on a ballistic missile, bomb, etc. The provisions themselves may however include explosives, explosive rounds, explosive ammunition, etc., for use by an individual such as a troop or an operative. The provisions may also include supplies, such as food, electronics, water, ammunition, etc. Additionally or alternatively, the payload 84 may include a deployable detection system such as a sonar buoy, radar emplacement, etc. for deployment at or near a target area.

To protect the payload 84 during landing of the payload container 50, the payload 84 may be wrapped or at least partially covered in a cushioning material. In some embodiments, inner walls defining the storage cavities 82 may include cushioning material for protecting a payload 84 during landing. In some embodiments the payload container 50 may include deployable cushions, such as air bags, for deployment at or prior to landing to protect the payload 84.

The payload container 50 also may include additional features to protect the payload 84. For example, the body 52 may include a survivability portion such as a crushable portion 90 (FIGS. 4A and 4B). The crushable portion 90 has lesser impact strength than adjacent portions allowing the crushable portion 90 to be crushable upon impact during landing. The crushing of the crushable portion 90 may relieve the payload 84 of at least some of the force of an impact, such as with land or water. In one embodiment shown in the FIGS. 4A and 4B, the crushable portion 90 is included in a nose cone portion of the payload container 50 and includes a crushable internal honeycomb structure. The honeycomb structure may be made of aluminum or any other suitable material. In other embodiments, the crushable portion 90 may include open and/or closed cell foam.

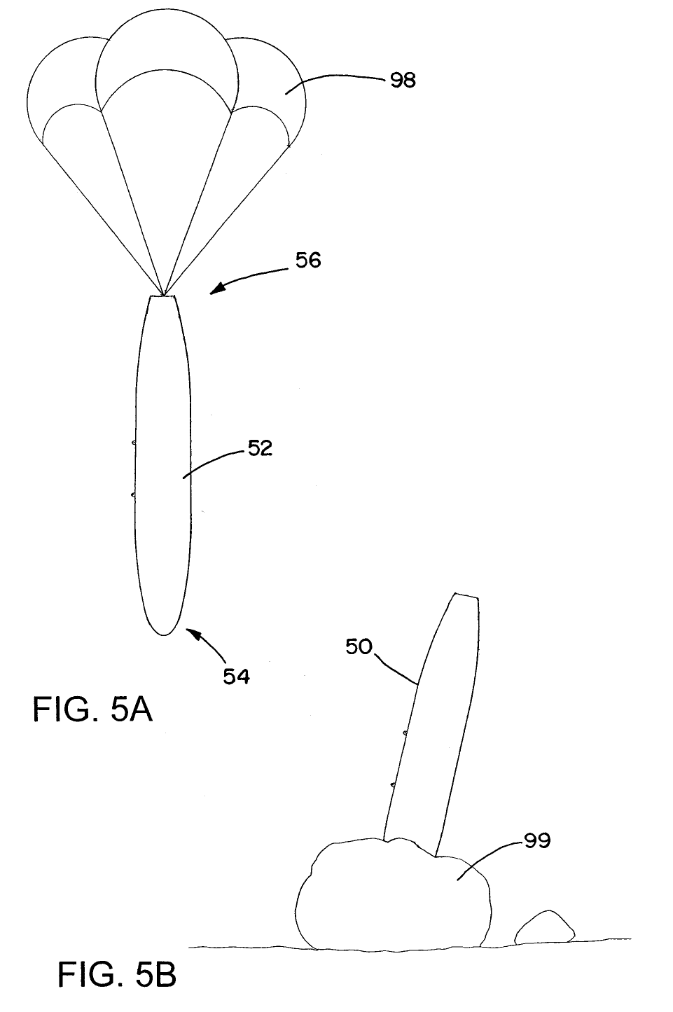

In some embodiments, shown in FIGS. 5A and 5B, the payload container 50 may include a survivability portion, such as a landing chute, and for example a parachute 98, which is shown as a drogue chute (FIG. 5A). In some embodiments the payload container 50 may include other survivability portions such as deployable landing cushions, and for example air bags 99 (FIG. 5B). The landing cushions may be fillable and expandable with gas or foam. In still other embodiments foam may deploy to protect the payload container 50 from a full force of a landing impact.

In some embodiments the payload container 50 may include a guidance device 94 (FIG. 3A), such as a global positioning system (GPS) or an altimeter, for assisting in guiding or directing the released payload container 50 towards a target area. The GPS or altimeter may be communicatively connected to a controller 96 and to one or more of the guide portions 64 and/or a survivability portion such as a drogue chute 98 or landing cushion 99. Upon receiving a signal from the guidance device 94 identifying the positioning of the payload container 50 at a specific distance or a specific altitude from the target area, the controller 96 may in turn provide a signal to the one or more guide portions 64 and/or to the survivability portion to release, deploy, adjust, etc.

The payload container 50 may be controlled autonomously by a controller, such as the controller 96. Additionally or alternatively, the payload container 50 may be controlled via an external source, such as a pilot interface communicatively connected to the payload container 50 via radio signal, satellite signal, or other suitable communicative connection. In such case the payload container 50 may include a suitable transmitter for sending and receiving communication signals.

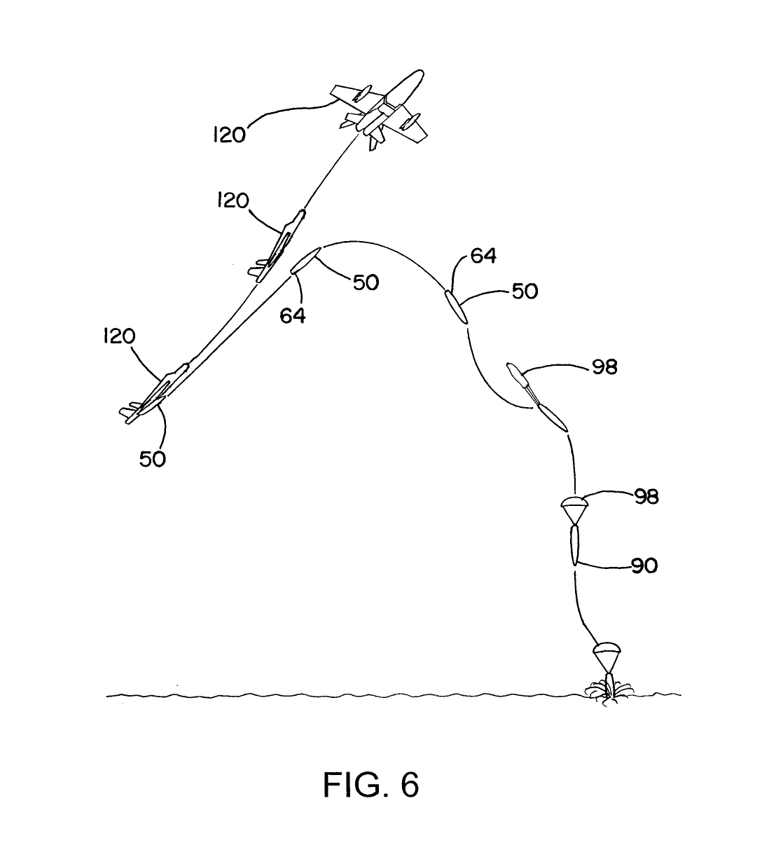

Turning now to FIG. 6, a schematic release of the payload container 50 from an aircraft 120 is illustrated. The schematic illustrates steps occurring after loading of a payload 84 into a storage cavity 82 of the payload container 50.

Prior to release of the payload container 50 from the aircraft 120, the aircraft 120 is preferably flying at an upwards trajectory. The associated container attachment interface and aircraft attachment interface will unlock and the payload container 50 will be released, preferably while the aircraft 120 is flying at the upwards trajectory. The upwards angle at the time of release of the payload container 50 may be any suitable angle, and preferably between 30 and 60 degrees, and more preferably between 40-50 degrees, such as 45 degrees.

During a non-propelled separation of the payload container 50 from the aircraft 120, the payload container 50 will move away from the aircraft 120 due to its own kinetic energy moving the payload container 50. This lobbing, or throwing of the payload container 50 at a high arc may enable the payload container 50 to be released with the container 50 and the aircraft 120 being generally undetected. Accordingly, the lobbing may enable the container 50 to continue unguided or minimally guided along the forward component of the trajectory at which the aircraft 120 was moving prior to release of the payload container 50. The payload container 50 may be released or lobbed at an altitude range of at least 0.3 km to 15.0 km and preferably at an altitude range of 10.5 km to 13.8 km.

After release of the payload container 50 from the aircraft 120, the aircraft may fall or glide unguided or minimally guided for a distance. Additionally or alternatively the guide portions 64 may be adjusted to assist in guiding the payload container 50 towards a target area. The payload container 50 may be guided for long distances, such as up to 100 km, and preferably up to 60 km, from a point of lobbing release from the aircraft 120.

As previously described, the one or more guide portions 64 may include a chute, fins, flippers, a wing, a sail, a propeller, etc., which may be deployed and adjusted to guide the payload container 50. Prior to landing, one or more survivability portions, such as a chute 98, may be deployed to reduce impact of a landing. Additionally or alternatively the payload container 50 may include a crushable portion 90 which will crush upon landing reducing impact of the landing to the carried payload 84 (FIGS. 4A and 4B). After landing, the payload 84 may be removed or separated from the payload container 50 via the opening 86 in the payload container, sealed such as by the access door 88 (FIG. 4A), or via separation of the nose and or tail sections 85 or 89 from the intermediate section 87 (FIG. 4B).

In one embodiment a replenishment vehicle, such as a special forces replenishment vehicle, is configured for being carried by and released from an aircraft. The replenishment vehicle, also referred to as a payload container, includes a storage cavity for storing a payload for being delivered to a target area. The payload may include any suitable provisions, and preferably provisions that are non-explosive during landing of the payload container, such as supplies for troops/operatives in the field, self-deploying radar or other detection devices, etc. The payload container is lobbed from the aircraft, such that the payload container is released while the aircraft is proceeding at an upwards trajectory. The payload container may be guided towards the target area by a guide portion such as a fin, wing, sail, chute, etc. The payload container is configured to enable the payload to survive release of the payload container from the aircraft and a subsequent landing.

In another embodiment a payload container includes at least one fin guide portion, a chute survivability portion and a crushable nosecone portion. Thus the payload container is configured for enabling a payload carried within to survive a lobbing from a respective aircraft and a subsequent landing at land or at sea.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A method of deploying a payload container containing a payload from an aircraft, the method including:
lobbing the payload container from the aircraft;
guiding the payload container towards a target area by adjusting a guide portion of the payload container; and
following the guiding, landing the payload container with the payload surviving the landing.

2. The method of claim 1, wherein adjusting the guide portion includes deploying a sail.

3. The method of claim 1, wherein adjusting the guide portion includes deploying a chute.

4. The method of claim 1, wherein adjusting the guide portion includes adjusting an angle of an airfoil.

5. The method of claim 1, wherein landing the payload container with the payload surviving the landing includes crushing a crushable portion of the payload container having lesser impact strength than adjacent portions, the crushable portion being deformable upon impact.

6. The method of claim 1, wherein landing the payload container with the payload surviving the landing includes deploying a chute.

7. The method of claim 1, wherein lobbing the payload container from the aircraft includes lobbing the payload container from a fighter aircraft.

8. The method of claim 1, wherein the lobbing the payload container includes releasing the payload container from the aircraft while at an altitude of at least 8 km.

9. A method of providing a non-explosive payload to a target area, the method including:
storing the payload in a cavity of a payload container;
loading the payload container onto an aircraft;
flying the aircraft at an upwards trajectory;
releasing the payload container from the aircraft while at the upwards trajectory;
guiding the payload container towards the target area after releasing the payload container;
survivably landing the payload container; and
separating the payload from the payload container.

10. The method of claim 9, wherein survivably landing the payload container includes crushing a crushable portion of the payload container having lesser impact strength than adjacent portions, the crushable portion being deformable upon impact.

11. The method of claim 9, wherein survivably landing the payload container includes deploying a chute.

12. The method of claim 9, wherein guiding the payload container includes adjusting a guide portion of the payload container to adjust the trajectory of the payload container.

13. The method of claim 9, wherein the releasing the payload container includes releasing at an altitude of at least 8 km.

14. A payload container for lobbing from an aircraft, the payload container comprising:
an outer body defining an interior cavity for storing a payload;
an attachment interface attachable to the aircraft; and
a guide portion activatable upon detachment of the payload container from the aircraft to guide the payload container towards a target area;
wherein the outer body extends along a longitudinal axis between a lead end and a tail end, at least one of the lead or tail ends having an ogive-shaped axial end, and the outer body being streamlined between the lead and tail ends.

15. The payload container of claim 14, wherein the guide portion is a chute.

16. The payload container of claim 14, wherein the guide portion is a sail.

17. The payload container of claim 14, wherein the guide portion is an airfoil.

18. The payload container of claim 14, wherein the outer body includes a crushable portion having lesser impact strength than adjacent portions, the crushable portion being deformable upon impact.

19. The payload container of claim 14, in combination with a fighter aircraft having an aircraft attachment interface for receiving the payload container attachment interface.

20. The payload container of claim 14, wherein the guide portion extends from an external surface of the outer body.
